(19) United States
(12) Patent Application Publication
(10) Pub. No.: US 2024/0088375 A1
(43) Pub. Date: Mar. 14, 2024

(54) POSITIVE ACTIVE MATERIAL FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventor: Youngjoo CHAE, Yongin-si (KR)

(21) Appl. No.: 18/347,429

(22) Filed: Jul. 5, 2023

(30) Foreign Application Priority Data
Aug. 26, 2022 (KR) 10-2022-0107852

(51) Int. Cl. H01M 4/505; C01G 53/00; H01M 4/131; H01M 4/525

(52) U.S. Cl. CPC H01M 4/505; C01G 53/50; H01M 4/131; H01M 4/525; C01P 2004/03; C01P 2006/40; H01M 2004/028

(57) ABSTRACT

A positive active material for a rechargeable lithium battery and rechargeable lithium battery including the same. The positive active material including first positive active material in a form of secondary particles in which a plurality of primary particles are aggregated, and including a lithium nickel-based composite oxide having a nickel content of greater than or equal to about 80 mol % based on the total amount of elements in the lithium nickel-based composite oxide excluding lithium and oxygen, and second positive active material in a form of single particles, including a lithium nickel-based composite oxide having a nickel content of greater than or equal to about 80 mol % based on the total amount of elements in the lithium nickel-based composite oxide of the second positive active material excluding lithium and oxygen wherein the lithium nickel-based composite oxide of the second positive active material includes Ni, Co, Mn, Al, Zr, and Mg.

### CROSS-REFERENCE TO RELATED APPLICATION

This application claims priority to and the benefit of Korean Patent Application No. 10-2022-0107852, filed in the Korean Intellectual Property Office on Aug. 26, 2022, the entire content of which is hereby incorporated by reference.

### BACKGROUND

### 1. Field

Embodiments of the present disclosure relate to a positive active material for a rechargeable lithium battery and a rechargeable lithium battery including the same.

### 2. Description of the Related Art

Portable information devices such as cell phones, laptops, smart phones, and/or the like or electric vehicles have used rechargeable lithium batteries having high energy densities and easy portability as driving power sources. Recently, research has been actively conducted to use rechargeable lithium batteries with high energy densities as driving power sources or power storage power sources for hybrid or electric vehicles.

Various positive active materials have been investigated in order to apply rechargeable lithium batteries to the aforementioned uses. Among them, lithium nickel-based oxide, lithium nickel manganese cobalt composite oxide, lithium nickel cobalt aluminum composite oxide, lithium cobalt oxide, and/or the like are mainly utilized as a positive active material.

Recently, high nickel-based positive active materials have been applied to secure high capacity. In addition, in order to increase energy density, a positive active material in which large and small particles with different particle sizes are mixed in an appropriate or suitable ratio has been developed, but they can suffer from the problem of cracks inside the particles during long-term charge and discharge cycles. The cracks may cause a side reaction of the positive active material with an electrolyte, which generates gas and thus deteriorates safety and also, depletes the electrolyte and thus deteriorates battery performance. Accordingly, in order to meet demands for a long life cycle, a single particle-type or kind nickel-based positive active material having relatively less cracks and a small specific surface area to reduce the side reaction with the electrolyte has been developed. However, the single particles may also have internal cracks, when increasing electrode density and running long-term cycles, which may lead to a deteriorating life cycle.

### SUMMARY

Aspects of one or more embodiments of the present disclosure are directed toward a rechargeable lithium battery realizing high capacity by applying a high nickel-based positive active material, in which a positive active material in a form of secondary particles and a positive active material in a form of single particles are mixed to increase energy density, and strength of the positive active material particles is increased to prevent or reduce cracks even during the long-term cycles, improving long life cycle characteristics.

Additional aspects will be set forth in part in the description which follows and, in part, will be apparent from the description, or may be learned by practice of the presented embodiments of the disclosure.

In one or more embodiments of the present disclosure, a positive active material for a rechargeable lithium battery includes a first positive active material in a form of secondary particles in which a plurality of primary particles are aggregated, including a lithium nickel-based composite oxide having a nickel content (e.g., amount) of greater than or equal to about 80 mol % based on the total amount of elements in the lithium nickel-based composite oxide of the first positive active material excluding lithium and oxygen, and a second positive active material in a form of single particles, including a lithium nickel-based composite oxide having a nickel content (e.g., amount) of greater than or equal to about 80 mol % based on the total amount of elements in the lithium nickel-based composite oxide of the second positive active material excluding lithium and oxygen, wherein the lithium nickel-based composite oxide of the second positive active material includes Ni, Co, Mn, Al, Zr, and Mg.

In one or more embodiments of the present disclosure, a rechargeable lithium battery includes a positive electrode including the positive active material, a negative electrode, and an electrolyte.

The positive active material for a rechargeable lithium battery according to one or more embodiments of the present disclosure and the rechargeable lithium battery including the same may suppress or reduce cracks from being generated inside the positive active material during long-term cycles and thus may realize long-term life cycle characteristics as well as may realize high capacity and high energy density.

### BRIEF DESCRIPTION OF THE DRAWINGS

FIG. 1 is a schematic view illustrating a rechargeable lithium battery according to one or more embodiments of the present disclosure.

FIG. 2 is a scanning electron microscope (SEM) image of a fracture surface of a positive active material taken after 600 cycles of the battery cell of Comparative Example 1.

FIG. 3 is an SEM image of the fracture surface of the positive active material taken after 600 cycles of the battery cell of Example 1.

FIG. 4 is a graph showing life cycle characteristics of the battery cells of Example 1, Comparative Examples 1 to 2, and Reference Examples 1 to 5.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terminology used herein is for the purpose of describing particular embodiments only and is not intended to limit the present disclosure. As used herein, the singular forms “a,” “an” and “the” are intended to include the plural forms as well, unless the context clearly indicates otherwise.

As used herein, “a combination thereof” refers to a mixture, a laminate, a composite, a copolymer, an alloy, a blend, a reaction product, and/or the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout, and duplicative descriptions thereof may not be provided the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

In addition, “layer” herein includes not only a shape formed on the whole surface when viewed from a plan view, but also a shape formed on a partial surface.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope, a transmission electron microscope, or a particle size analyzer. It is also possible to obtain an average particle diameter value by measuring using a dynamic light scattering method, performing data analysis, counting the number of particles for each particle size range, and calculating from this. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

Herein, “or” is not to be construed as an exclusive meaning, for example, “A or B” is construed to include A, B, A+B, and/or the like. As used herein, the term “and/or” includes any and all combinations of one or more of the associated listed items. As used herein, “/” may be interpreted as “and”, or as “or” depending on the context.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

### Positive Active Material

In one or more embodiments, a positive active material for a rechargeable lithium battery includes: a first positive active material in a form of secondary particles in which a plurality of primary particles are aggregated (e.g., each of the secondary particles, i.e., one second particle, is an aggregate of at least two or more primary particles), including a lithium nickel-based composite oxide having a nickel content (e.g., amount) of greater than or equal to about 80 mol % based on the total amount of elements excluding lithium and oxygen; and a second positive active material in a form of single particles (e.g., a single continuous phase or body particle), including a lithium nickel-based composite oxide having a nickel content (e.g., amount) of greater than or equal to about 80 mol % based on the total amount of elements excluding lithium and oxygen. The lithium nickel-based composite oxide of the second positive active material includes Ni, Co, Mn, Al, Zr, and Mg. The first positive active material and the second positive active material have high particle strength, so that generation of internal cracks is suppressed or reduced even after a long cycle, and thus, long life cycle characteristics are improved, and at the same time, high capacity and high energy density may be realized.

### First Positive Active Material

The first positive active material has a polycrystal form, and includes secondary particles formed by aggregation of at least two or more primary particles.

An average particle diameter (D50) of the first positive active material, that is, the average particle diameter of the secondary particles may be about 5 μm to about 25 μm. For example, it may be about 7 μm to about 25 μm, about 9 μm to about 25 μm, about 10 μm to about 25 μm, or about 10 μm to about 20 μm. The average particle diameter of the secondary particles of the first positive active material may be the same as or greater than the average particle diameter of the single-particle second positive active material, which will be described in more detail later. The positive active material according to one or more embodiments may be in the form of a mixture of the first positive active material, which is polycrystalline and large particles, and the second positive active material, which is single particles and small particles, thereby improving a mixture density, and providing high capacity and high energy density. Herein, the average particle diameter of the first positive active material may be obtained by randomly selecting 30 secondary particle-type or kind active materials from the electron microscope image of the positive active material to measure a particle diameter (e.g., an average of 30 randomly selected secondary particles), and taking the particle diameter (D50) of the particles having a cumulative volume of 50 volume % in the particle size distribution as the average particle diameter.

The first positive active material includes a lithium nickel-based composite oxide and corresponds to a high nickel-based positive active material. A content (e.g., amount) of nickel in the lithium nickel-based composite oxide may be greater than or equal to about 80 mol %, for example, greater than or equal to about 85 mol %, greater than or equal to about 89 mol %, greater than or equal to about 90 mol %, greater than or equal to about 91 mol %, or greater than or equal to about 94 mol %, and less than or equal to about 99.9 mol %, or less than or equal to about 99 mol % based on the total amount of elements in the lithium nickel-based composite oxide of the first positive active material, excluding lithium and oxygen. When the nickel content (e.g., amount) satisfies the above ranges, the positive active material may exhibit excellent or suitable battery performance while realizing a high capacity.

The first positive active material may specifically include a lithium nickel-based composite oxide represented by Chemical Formula 1.

Liₐ₁Niₓ₁M¹_{y1}M²_{1-x1-y1}O₂ Chemical Formula 1

In Chemical Formula 1, 0.9≤a1≤1.8, 0.8≤x1≤1, 0≤y1≤0.2, and M¹ and M² may each independently be at least one element of (e.g., selected from) Al, B, Ba, Ca, Ce, Co, Cr, Cu, F, Fe, Mg, Mn, Mo, Nb, P, S, Si, Sr, Ti, V, W, and/or Zr.

In Chemical Formula 1, 0.85≤x1≤1 and 0≤y1≤0.15; or 0.9≤x1≤1 and 0≤y1≤0.1.

The first positive active material may include, for example, a lithium nickel-based composite oxide represented by Chemical Formula 2.

Liₐ₂Niₓ₂Co_{y2}M³_{1-x2-y2}O₂ Chemical Formula 2

In Chemical Formula 2, 0.9≤a2≤1.8, 0.8≤x2<1, 0<y2≤0.2, and M³ is at least one element of (e.g., selected from) Al, B, Ba, Ca, Ce, Cr, Cu, F, Fe, Mg, Mn, Mo, Nb, P, S, Si, Sr, Ti, V, W, and/or Zr.

In Chemical Formula 2, 0.85≤x2≤0.99 and 0.01≤y2≤0.15; or 0.9≤x2≤0.99 and 0.01≤y2≤0.1.

The first positive active material may include, for example, a compound of Chemical Formula 3.

Liₐ₃Niₓ₃Co_{y3}M⁴_{z3}M⁵_{1-x3-y3-z3}O₂ Chemical Formula 3

In Chemical Formula 3, 0.9≤a3≤1.8, 0.8≤x3≤0.98, 0.01≤y3≤0.19, 0.01≤z3≤0.19, M⁴ is at least one element of (e.g., selected from) Al, and/or Mn, and M⁵ is at least one element of (e.g., selected from) B, Ba, Ca, Ce, Cr, Cu, F, Fe, Mg, Mo, Nb, P, S, Si, Sr, Ti, V, W, and/or Zr.

In Chemical Formula 3, 0.85≤x3≤0.98, 0.01≤y3≤0.14, and 0.01≤z3≤0.14; or 0.9≤x3≤0.98, 0.01≤y3≤0.09, and 0.01≤z3≤0.09.

### Second Positive Active Material

The second positive active material is in the form of a single particle, exists alone without a grain boundary within the particle, is composed of one particle, and may be single particle or have a monolith structure or an one body structure, in which particles are not aggregated with each other but exist as an independent phase in terms of morphology, or a non-aggregated particle, and may be expressed as a single particle (one body particle, single grain), for example, as a monocrystal (single crystal). The positive active material according to one or more embodiments may include the second positive active material in the form of single particles, thereby exhibiting improved life cycle characteristics while implementing high capacity and high energy density.

The second positive active material includes a lithium nickel-based composite oxide, and the lithium nickel-based composite oxide includes Ni, Co, Mn, Al, Zr, and Mg. For example, the lithium nickel-based composite oxide of the second positive active material may include Ni, Co, and Mn as transition metals, and may include all of Al, Zr, and Mg as a type or kind of doping element. The particle strength of the second positive active material is improved, and internal cracks may not occur even after repeated charging and discharging for a long time, thereby maintaining excellent or suitable performance.

The second positive active material corresponds to a high nickel-based positive active material like the first positive active material. The nickel content (e.g., amount) in the lithium nickel-based composite oxide may be greater than or equal to about 80 mol %, for example, greater than or equal to about 85 mol %, greater than or equal to about 89 mol %, greater than or equal to about 90 mol %, greater than or equal to about 91 mol %, or greater than or equal to about 94 mol %, and less than or equal to about 99.9 mol %, or less than or equal to about 99 mol % based on the total amount of elements in the lithium nickel-based composite oxide of the second positive active material, excluding lithium and oxygen. When the nickel content (e.g., amount) satisfies the above ranges, the positive active material may exhibit excellent or suitable battery performance while realizing a high capacity.

In the second positive active material, an Al content (e.g., amount) based on the total amount of elements in the lithium nickel-based composite oxide of the second positive active material excluding lithium and oxygen may be greater than or equal to about 1.0 mol % and less than about 2.0 mol %, for example about 1.0 mol % to about 1.9 mol %, about 1.1 mol % to about 1.9 mol %, about 1.2 mol % to about 1.8 mol %, or about 1.3 mol % to about 1.7 mol %. When the Al content (e.g., amount) is as above, the second positive active material may maintain high strength even over a long life cycle, thereby improving life cycle characteristics of the rechargeable lithium battery, and implementing high capacity and high energy density.

In the second positive active material, a Zr content (e.g., amount) based on the total amount of elements excluding lithium and oxygen may be greater than or equal to about 0.5 mol % and less than about 1.0 mol %, for example about 0.5 mol % to about 0.9 mol %, about 0.5 mol % to about 0.8 mol %, or about 0.5 mol % to about 0.7 mol %. When the Zr content (e.g., amount) is as above, the second positive active material may maintain high strength even over a long life cycle, thereby improving life cycle characteristics of the rechargeable lithium battery, and implementing high capacity and high energy density.

In the second positive active material, an Mg content (e.g., amount) based on the total amount of elements excluding lithium and oxygen may be greater than or equal to about 0.1 mol % and less than about 1.0 mol %, for example about 0.1 mol % to about 0.9 mol %, about 0.2 mol % to about 0.8 mol %, or about 0.3 mol % to about 0.7 mol %. When the Mg content (e.g., amount) is as above, the second positive active material may maintain high strength even over a long life cycle, thereby improving life cycle characteristics of the rechargeable lithium battery, and implementing high capacity and high energy density.

The lithium nickel-based composite oxide of the second positive active material may be, for example, represented by Chemical Formula 4.

Liₐ₄Niₓ₄Co_{y4}Mn_{z4}Al_{b4}Zr_{c4}Mg_{d4}M⁶_{(1-x4-y4-z4-b4-c4-d4)}O₂ Chemical Formula 4

In Chemical Formula 4, 0.9≤a4≤1.8, 0.8≤x4<1, 0<y4≤0.184, 0<z4≤0.184, 0.01≤b4<0.02, 0.005≤c4<0.01, 0.001≤d4<0.01, and M⁶ is at least one element of (e.g., selected from) B, Ba, Ca, Ce, Cr, Cu, F, Fe, Mo, Nb, P, S, Si, Sr, Ti, V, and/or W.

In Chemical Formula 4, 0.85≤x4<1, 0<y4≤0.134, 0<z4≤0.134; or 0.9≤x4<1, 0<y4≤0.084, 0<z4≤0.084. In one or more embodiments, 0.01≤b4≤0.019, 0.011≤b4≤0.019, or 0.012≤b4≤0.018; 0.005≤c4≤0.009 or 0.005≤c4≤0.008; and/or 0.001≤d4≤0.009, or 0.002≤d4≤0.008.

When the second positive active material includes the lithium nickel-based composite oxide represented by Chemical Formula 4, particle strength is improved, so that long life cycle characteristics may be improved, and high capacity and high energy density may be realized.

An average particle diameter of the second positive active material, that is, the average particle diameter of the single particles may be about 0.05 μm to about 7 μm, for example, about 0.1 μm to about 7 μm, about 0.5 μm to about 6 μm, or about 1 μm to about 5 μm, or about 0.5 μm to about 7 μm. The particle diameter of the second positive active material may be the same as or smaller than that of the first positive active material, and thus the density of the positive active material may be further increased. Herein, the average particle diameter of the second positive active material may be obtained by randomly selecting 30 single-particle active materials from the electron microscope image of the positive active material to measure a particle diameter, and taking the particle diameter (D50) of the particles having a cumulative volume of 50 volume % in the particle size distribution as the average particle diameter.

In the positive active material according to one or more embodiments, the first positive active material may be included in an amount of about 50 wt % to about 90 wt %, and the second positive active material may be included in an amount of about 10 wt % to about 50 wt % based on the total amount of the first positive active material and the second positive active material. The first positive active material may be for example included in an amount of about 60 wt % to about 90 wt %, or about 70 wt % to about 90 wt % and the second positive active material may be for example included in an amount of about 10 wt % to about 40 wt %, or about 10 wt % to about 30 wt %. When the content (e.g., amount) ratio of the first positive active material and the second positive active material is as described above, the positive active material including the same may realize high capacity, improve a mixture density, and exhibit high energy density.

In one or more embodiments, a method of preparing a positive active material for a rechargeable lithium battery includes (i) preparing a first positive active material in a form of secondary particles in which a plurality of primary particles are aggregated, including a lithium nickel-based composite oxide having a nickel content (e.g., amount) of greater than or equal to about 80 mol % based on the total amount of elements in the lithium nickel-based composite oxide excluding lithium and oxygen, (ii) mixing a nickel-based composite hydroxide containing Ni, Co, and Mn, and having a nickel content (e.g., amount) of greater than or equal to about 80 mol % based on all elements excluding oxygen and hydrogen, a lithium raw material, an Al raw material, a Zr raw material, and a Mg raw material and performing heat treatment to prepare a second positive active material in the form of a single particle, and (iii) mixing the first positive active material with the second positive active material. Accordingly, the aforementioned positive active material may be prepared. The prepared positive active material may exhibit excellent or suitable long life cycle characteristics by maintaining high particle strength without internal cracks occurring in the positive active material particles over a long cycle while implementing high capacity and high energy density.

In step (ii), the content (e.g., amount) of the Al raw material may be greater than or equal to about 1.0 mol % and less than about 2.0 mol % based on the total amount of elements excluding oxygen and hydrogen in the nickel-based composite hydroxide. In one or more embodiments, the content (e.g., amount) of the Zr raw material may be greater than or equal to about 0.5 mol % and less than about 1.0 mol % based on the total amount of elements excluding oxygen and hydrogen in the nickel-based composite hydroxide. The content (e.g., amount) of the Mg raw material may be greater than or equal to about 0.1 mol % and less than about 1.0 mol % based on the total amount of elements excluding oxygen and hydrogen in the nickel-based composite hydroxide.

In step (ii), the heat treatment may be performed, for example, in an oxygen atmosphere, and may be performed at a temperature range of about 700° C. to about 1000° C. for about 5 hours to about 25 hours. In one or more embodiments, the method for preparing the positive active material may further include pulverizing the obtained product to obtain a single particle shape after the heat treatment.

In step (iii), the first positive active material and the second positive active material may be mixed in a weight ratio of about 50:50 to about 90:10, for example, in a weight ratio of about 60:40 to about 80:20. In these cases, high capacity and high energy density may be realized at the same time.

In the method of preparing the positive active material, the nickel-based composite hydroxide is a positive active material precursor, and may be prepared by a general co-precipitation method, for example, by mixing metal raw materials with a complexing agent and a precipitating agent in a solvent.

### Positive Electrode

A positive electrode for a rechargeable lithium battery may include a current collector and a positive active material layer on the current collector. The positive active material layer may include a positive active material, and may further include a binder and/or a conductive material.

The binder improves binding properties of positive active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The content (e.g., amount) of the binder in the positive active material layer may be about 1 wt % to about 5 wt % based on the total weight of the positive active material layer.

The conductive material is included to provide electrode conductivity and any electrically conductive material may be utilized as a conductive material unless it causes a chemical change in a battery. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum silver, and/or the like; a conductive polymer such as a polyphenylene derivative; or a mixture thereof.

The content (e.g., amount) of the conductive material in the positive active material layer may be about 1 wt % to about 5 wt % based on the total weight of the positive active material layer.

An aluminum foil may be utilized as the positive electrode current collector, but the present disclosure is not limited thereto.

### Negative Electrode

A negative electrode for a rechargeable lithium battery includes a current collector and a negative active material layer on the current collector. The negative active material layer may include a negative active material, and may further include a binder and/or a conductive material.

The negative active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include, for example crystalline carbon, amorphous carbon, or a combination thereof as a carbon-based negative active material. The crystalline carbon may be non-shaped, or sheet, flake, spherical, or fiber shaped natural graphite or artificial graphite.

The amorphous carbon may be a soft carbon, a hard carbon, a mesophase pitch carbonization product, calcined coke, and/or the like.

The lithium metal alloy includes an alloy of lithium and a metal including (e.g., selected from) Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative active material or a Sn-based negative active material. The Si-based negative active material may include silicon, a silicon-carbon composite, SiOₓ (0<x<2), a Si-Q alloy (wherein Q is an element including (e.g., selected from) an alkali metal, an alkaline-earth metal, a Group 13 element, a Group 14 element, a Group 15 element, a Group 16 element, a transition metal, a rare earth element, and/or a combination thereof, but not Si) and the Sn-based negative active material may include Sn, SnO₂, a Sn—R alloy (wherein R is an element including (e.g., selected from) an alkali metal, an alkaline-earth metal, a Group 13 element, a Group 14 element, a Group 15 element, a Group 16 element, a transition metal, a rare earth element, and/or a combination thereof, but not Sn). At least one of these materials may be mixed with SiO₂. The elements Q and R may be (e.g., may be selected from) Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and/or a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In one or more embodiments, the content (e.g., amount) of silicon may be about 10 wt % to about 50 wt % based on the total weight of the silicon-carbon composite. In one or more embodiments, the content (e.g., amount) of the crystalline carbon may be about 10 wt % to about 70 wt % based on the total weight of the silicon-carbon composite, and the content (e.g., amount) of the amorphous carbon may be about 20 wt % to about 40 wt % based on the total weight of the silicon-carbon composite. In one or more embodiments, a thickness of the amorphous carbon coating layer may be about 5 nm to about 100 nm. An average particle diameter (D50) of the silicon particles may be about 10 nm to about 20 μm. In one or more embodiments, the average particle diameter (D50) of the silicon particles may be about 10 nm to about 200 nm. The silicon particles may exist in an oxidized form, and in this case, an atomic content (e.g., amount) ratio of Si:O in the silicon particles indicating a degree of oxidation may be about 99:1 to about 33:67. The silicon particles may be SiOₓ particles, and in this case, the range of x in SiOₓ may be greater than about 0 and less than about 2. In the present specification, unless otherwise defined, an average particle diameter (D50) indicates a particle diameter where an accumulated volume is about 50 volume % in a particle size distribution.

The Si-based negative active material or Sn-based negative active material may be mixed with the carbon-based negative active material. When the Si-based negative active material or Sn-based negative active material and the carbon-based negative active material are mixed and utilized, the mixing ratio may be a weight ratio of about 1:99 to about 90:10.

In the negative active material layer, the negative active material may be included in an amount of about 95 wt % to about 99 wt % based on the total weight of the negative active material layer.

In one or more embodiments, the negative active material layer further includes a binder, and may optionally further include a conductive material. The content (e.g., amount) of the binder in the negative active material layer may be about 1 wt % to about 5 wt % based on the total weight of the negative active material layer. In one or more embodiments, when the conductive material is further included, the negative active material layer may include about 90 wt % to about 98 wt % of the negative active material, about 1 wt % to about 5 wt % of the binder, and about 1 wt % to about 5 wt % of the conductive material.

The binder serves to well adhere the negative active material particles to each other and also to adhere the negative active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may include (e.g., may be selected from) a styrene-butadiene rubber, an acrylated styrene-butadiene rubber, an acrylonitrile-butadiene rubber, an acrylic rubber, a butyl rubber, a fluororubber, and/or a combination thereof. The polymer resin binder may include (e.g., may be selected from) polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and/or a combination thereof.

When a water-soluble binder is utilized as the negative electrode binder, a cellulose-based compound capable of imparting viscosity may be further included as a thickener. As the cellulose-based compound, one or more of carboxymethyl cellulose, hydroxypropylmethyl cellulose, methyl cellulose, or alkali metal salts thereof may be mixed and utilized. The alkali metal may include Na, K, or Li. The amount of the thickener utilized may be about 0.1 parts by weight to about 3 parts by weight based on 100 parts by weight of the negative active material.

The conductive material is included to provide electrode conductivity and any electrically conductive material may be utilized as a conductive material unless it causes a chemical change in a battery. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder or a metal fiber including copper, nickel, aluminum silver, and/or the like; a conductive polymer such as a polyphenylene derivative; or a mixture thereof.

The negative electrode current collector may include (e.g., may be selected from) a copper foil, a nickel foil, a stainless steel foil, a titanium foil, a nickel foam, a copper foam, a polymer substrate coated with conductive metal, and/or a combination thereof.

### Rechargeable Lithium Battery

One or more embodiments of the present disclosure provide a rechargeable lithium battery including a positive electrode, a negative electrode, a separator between the positive electrode and the negative electrode, and an electrolyte.

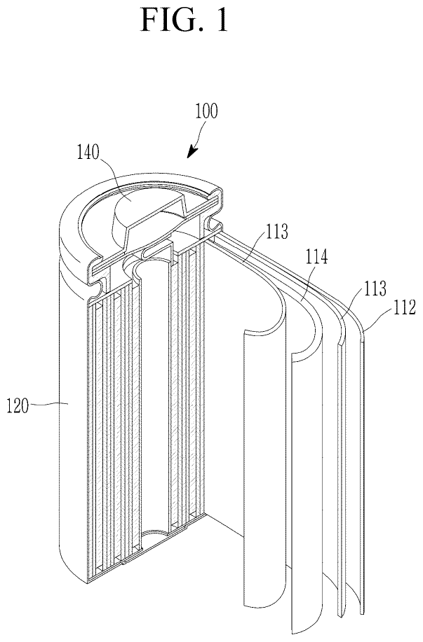

FIG. 1 is a schematic view illustrating a rechargeable lithium battery according to one or more embodiments of the present disclosure. Referring to FIG. 1, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or an aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like and the ketone-based solvent may be cyclohexanone, and/or the like. In one or more embodiments, the alcohol-based solvent may be ethyl alcohol, isopropyl alcohol, etc. and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. When the organic solvent is utilized in a mixture, the mixture ratio may be controlled or selected in accordance with a desirable battery performance.

In one or more embodiments, in the case of the carbonate-based solvent, a mixture of a cyclic carbonate and a chain carbonate may be utilized. In these cases, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In such cases, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be utilized.

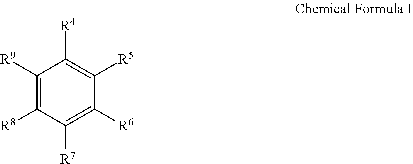

In Chemical Formula I, R⁴ to R⁹ may each independently be the same or different and may include (e.g., may be selected from) hydrogen, a halogen, a C1 to C10 alkyl group, a C1 to C10 haloalkyl group, and/or a combination thereof.

Specific examples of the aromatic hydrocarbon-based solvent may be (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may further include vinylene carbonate or an ethylene carbonate-based compound of Chemical Formula II in order to improve the life cycle of a battery.

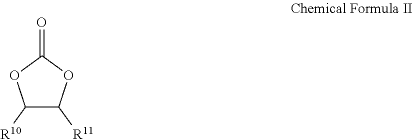

In Chemical Formula II, R¹⁰ and R¹¹ may each independently be the same or different, and may include (e.g., may be selected from) hydrogen, a halogen, a cyano group, a nitro group, and/or a fluorinated C1 to C5 alkyl group, provided that at least one of R¹⁰ and R¹¹ includes (e.g., is selected from) a halogen, a cyano group, a nitro group, and/or a fluorinated C1 to C5 alkyl group, but both of R¹⁰ and R¹¹ are not hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving life cycle characteristics may be utilized within an appropriate or suitable range.

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt may include one or more of (e.g., one or more selected from) LiPF₆, LiBF₄, LiSbF₆, LiAsF₆, LiN(SO₂C₂F₆)₂, Li(CF₃SO₂)₂N, LiN(SO₃C₂F₆)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are natural numbers, for example, integers from 1 to 20, lithium difluoro(bisoxalato) phosphate, LiCl, LiI, LiB(C₂O₄)₂ (lithium bis(oxalato) borate; LiBOB), and/or lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

The separator 113 separates a positive electrode 114 and a negative electrode 112 and provides a transporting passage for lithium ions and may be any generally-utilized separator in a lithium ion battery. In other words, it may have low resistance to ion transport and excellent or suitable impregnation for an electrolyte. For example, the separator 113 may include glass fiber, polyester, polyethylene, polypropylene, polytetrafluoroethylene, or a combination thereof, and may be in the form of a nonwoven fabric or a woven fabric. For example, in a lithium ion battery, a polyolefin-based polymer separator such as polyethylene and polypropylene may be mainly utilized. In order to ensure the heat resistance or mechanical strength, a coated separator including a ceramic component or a polymer material may be utilized. Optionally, it may have a mono-layered or multi-layered structure.

Rechargeable lithium batteries may be classified as lithium ion batteries, lithium ion polymer batteries, and lithium polymer batteries according to the presence of a separator and the kind of electrolyte utilized therein. The rechargeable lithium batteries may have a variety of shapes and sizes, and include cylindrical, prismatic, coin, or pouch-type or kind batteries, and may be thin film batteries or may be rather bulky in size. Structures and manufacturing methods for lithium ion batteries pertaining to this disclosure are generally available in the art.

The rechargeable lithium battery according to one or more embodiments may be utilized in an electric vehicle (EV), a hybrid electric vehicle such as a plug-in hybrid electric vehicle (PHEV), and/or portable electronic device because it implements a high capacity and has excellent or suitable storage stability, life cycle characteristics, and high rate characteristics at high temperatures.

Hereinafter, examples of the present disclosure and comparative examples are described. It is to be understood, however, that the examples are for the purpose of illustration and are not to be construed as limiting the present disclosure.

### Example 1

### 1. Preparation of First Positive Active Material in a Form of Secondary Particles

As metal raw materials, nickel sulfate (NiSO₄·6H₂O), cobalt sulfate (CoSO₄·7H₂O) and manganese sulfate (MnSO₄·H₂O) were mixed in a molar ratio of 95:4:1 and dissolved in distilled water as a solvent to prepare a mixed solution, and 10 wt % ammonia water (NH₄OH) was prepared to form a complex compound and 25 wt % sodium hydroxide (NaOH) was prepared as a precipitating agent.

After adding the dilute ammonia water solution to the continuous reactor, the metal raw material mixed solution was substantially continuously added, and sodium hydroxide was added to maintain the pH inside the reactor. After slowly conducting a reaction for about 80 hours, when the reaction was stabilized, a product overflown therefrom was collected and then, washed and dried, obtaining a final precursor. Accordingly, a first nickel-based hydroxide (Ni_{0.95}Co_{0.04}Mn_{0.01}(OH)₂) in the form of secondary particles in which primary particles are aggregated was obtained, washed and dried.

The first nickel-based hydroxide was mixed with LiOH so that a molar ratio of lithium to the total amount of metal of the first nickel-based hydroxide was 1.04, and the mixture was subjected to a first heat treatment at about 750° C. for 15 hours in an oxygen atmosphere to obtain the first positive active material (Li_{1.04}Ni_{0.95}Co_{0.04}Mn_{0.01}O₂). The obtained first positive active material was in the form of secondary particles in which primary particles were aggregated, and the secondary particle had an average particle diameter of about 15 μm.

### 2. Preparation of Second Positive Active Material in a Form of Single Particles

A mixed solution was prepared by dissolving nickel sulfate, cobalt sulfate, and manganese sulfate in distilled water in a molar ratio of 95:4:1. In order to form a complex, 10 wt % a dilute ammonia water (NH₄OH) solution was prepared and 25 wt % sodium hydroxide (NaOH) as a precipitant was prepared. Subsequently, the raw metal material mixed solution, the ammonia water, and the sodium hydroxide were each put into a reactor. Then, while stirred, a reaction proceeded for about 20 hours. Then, the slurry solution in the reactor was filtered, washed with high-purity distilled water, and dried for 24 hours to obtain a second nickel-based hydroxide powder (Ni_{0.95}Co_{0.04}Mn_{0.01}(OH)₂). The obtained second nickel-based hydroxide powder had an average particle diameter of about 4.0 μm.

The obtained second nickel-based hydroxide oxide and LiOH to satisfy Li/(Ni+Co+Mn)=1.05 (a molar ratio) were mixed with dopant components of 1.5 mol % of Al, 0.5 mol % of Zr, and 0.5 mol % of Mg based on 100 mol % of the total amount of elements excluding lithium and oxygen in a final second positive active material and then, put in a furnace and secondarily heat-treated under an oxygen atmosphere at 820° C. for 10 hours. Subsequently, a product therefrom was pulverized for about 30 minutes, obtaining a second positive active material (Li_{1.05}Ni_{0.93}Co_{0.035}Mn_{0.01}Al_{0.015}Mg_{0.005}Zr_{0.005}O₂) in a form of single particles. The single particle of the second positive active material had an average particle diameter of about 3.7 μm.

### 3. Preparation of Final Positive Active Material

The first positive active material and the second positive active material were mixed in a weight ratio of 7:3, obtaining a final positive active material.

### 4. Manufacture of Positive Electrode

95 wt % of the final positive active material, 3 wt % of a polyvinylidene fluoride binder, and 2 wt % of carbon nanotube conductive material were mixed in an N-methylpyrrolidone solvent to prepare a positive active material slurry. The positive active material slurry was applied to an aluminum current collector, dried, and then compressed to manufacture a positive electrode.

### 5. Manufacture of Coin Half-Cell

A coin half-cell was manufactured by disposing a separator having a polyethylene polypropylene multilayer structure disposed between the manufactured positive electrode and lithium metal counter electrode, and injecting an electrolyte in which 1.0 M LiPF₆ lithium salt was added to a solvent in which ethylene carbonate and diethyl carbonate were mixed in a volume ratio of 50:50.

### Comparative Examples 1 to 3 and Reference Examples 1 to 5

Each positive active material of each of the rechargeable lithium battery cells was manufactured in substantially the same manner as in Example 1 except that the composition of the second positive active material was changed as shown in Table 1.

TABLE 1

| | Content of dopant (mol %) |
|---|---|
| Example 1 | Al 1.5/Zr 0.5/Mg 0.5 |
| Comparative Example 1 | Al 0.2/Zr 0.2 |
| Comparative Example 2 | Al 1.5/Mg 0.5 |
| Reference Example 1 | Al 0.2/Zr 0.5/Mg 0.5 |
| Reference Example 2 | Al 2.0/Zr 0.5/Mg 0.5 |
| Reference Example 3 | Al 1.5/Zr 0.1/Mg 0.5 |
| Reference Example 4 | Al 1.5/Zr 1.0/Mg 0.5 |
| Reference Example 5 | Al 1.5/Zr 0.2/Mg 1.0 |

### Evaluation Example 1: Evaluation of Occurrence of Cracks in Particles During Long Cycle Repetition

The rechargeable lithium battery cells according to Example 1 and Comparative Example 1 were charged under conditions of a constant current (0.2 C) and a constant voltage (4.25 V, 0.05 C cut-off), paused for 10 minutes, and discharged to 3.0 V under conditions of constant current (0.2 C). Subsequently, the cells are charged and discharged for 600 cycles or more at 1 C at 45° C.

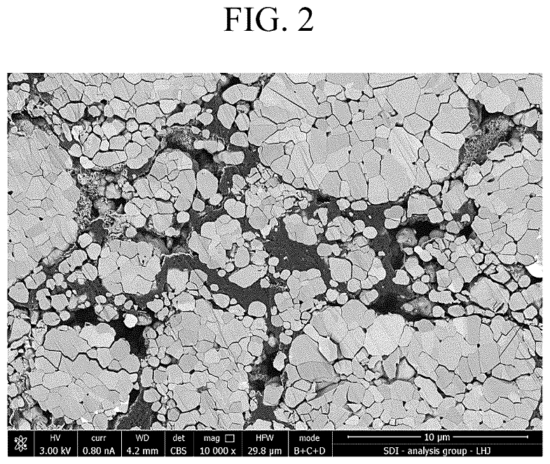

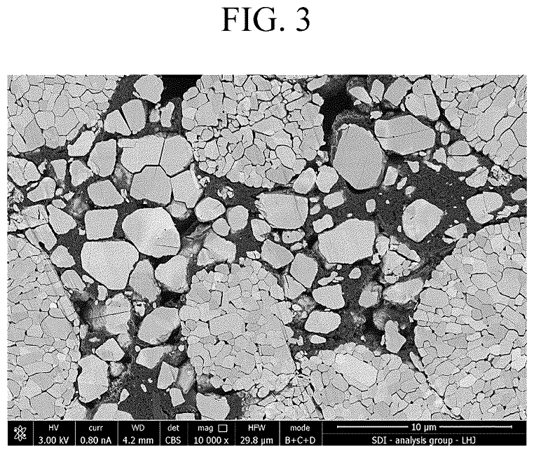

FIG. 2 is an SEM image of a fracture surface of the positive active material in the positive electrode after the battery cell of Comparative Example 1 was cycled 600 times. FIG. 3 is an SEM image of the fracture surface of the positive active material in the positive electrode after the battery cell of Example 1 was cycled 600 times.

Comparing FIG. 2 with FIG. 3, Comparative Example 1 of FIG. 2 shows that the second positive active material of single particles with a size of about 4 μm has internal cracks. In contrast, Example 1 of FIG. 3 shows that the second positive active material of single particles has no internal cracks but maintains its shape. The second positive active material according to one or more embodiments has high particle strength and thus no internal crack despite repeated cycles for a long time, and maintains excellent or suitable performance.

### Evaluation Example 2: Evaluation of Life Cycle Characteristics of Coin Half-Cells

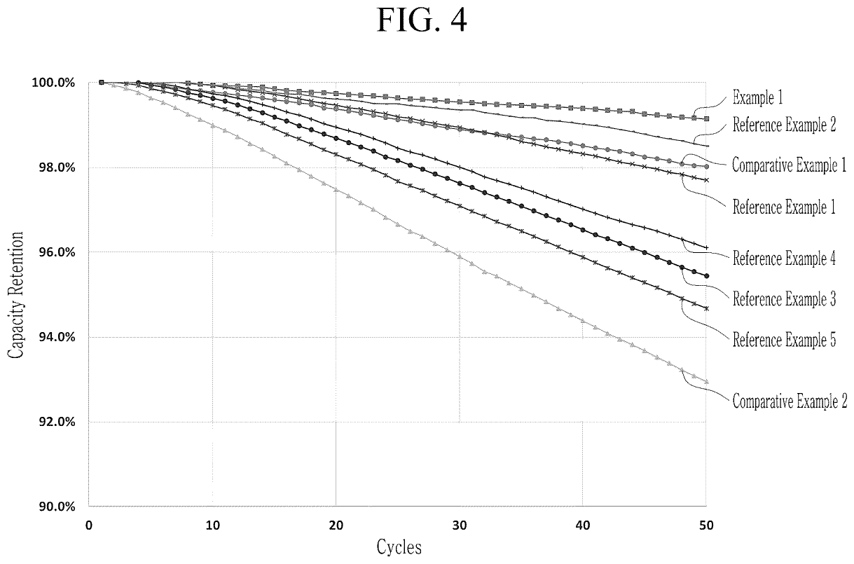

The coin half-cells of Example 1, Comparative Examples 1 to 2, and Reference Examples 1 to 5 were initially charged and discharged in substantially the same method as in Evaluation Example 1 and then, the cycles were repeated 50 times to evaluate capacity retention, and the results are show in FIG. 4.

Referring to FIG. 4, compared with Comparative Example 1 in which the Mg dopant is omitted in the second positive active material and Comparative Example 2 in which the Zr dopant is omitted in the second positive active material, Example 1 exhibits improved capacity retention at the 50^{th} cycle.

On the other hand, when the Al content (e.g., amount) is low (Reference Example 1), or when the Al content (e.g., amount) is high (Reference Example 2), the 50^{th} capacity retention is slightly lowered, compared with Example 1. In addition, when the Zr content (e.g., amount) is low (Reference Example 3) or high (Reference Example 4), and when the Mg content (e.g., amount) is high (Reference Example 5), the 50^{th} capacity retention is slightly lowered, compared with Example 1. In other words, a second positive active material may be doped with Al, Zr, and Mg concurrently (e.g., simultaneously) to increase particle strength and significantly improve long life cycle characteristics, but when each doping element is doped in a desired or suitable amount, overall battery performance may be further improved.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

Reference Numerals

| | |
|---|---|
| 100: rechargeable lithium battery | 112: negative electrode |
| 113: separator | 114: positive electrode |
| 120: battery case | 140: sealing member |

What is claimed is:

1. A positive active material for a rechargeable lithium battery, the positive active material comprising:
a first positive active material in a form of secondary particles in which a plurality of primary particles are aggregated, comprising a lithium nickel-based composite oxide having a nickel content of greater than or equal to about 80 mol % based on the total amount of elements in the lithium nickel-based composite oxide of the first positive active material excluding lithium and oxygen, and
a second positive active material in a form of single particles, comprising a lithium nickel-based composite oxide having a nickel content of greater than or equal to about 80 mol % based on the total amount of elements in the lithium nickel-based composite oxide of the second positive active material excluding lithium and oxygen,
wherein the lithium nickel-based composite oxide of the second positive active material comprises Ni, Co, Mn, Al, Zr, and Mg.

2. The positive active material of claim 1, wherein, in the second positive active material, an Al content based on the total amount of elements in the lithium nickel-based composite oxide of the second positive active material excluding lithium and oxygen is greater than or equal to about 1.0 mol % and less than 2.0 mol %.

3. The positive active material of claim 1, wherein, in the second positive active material, a Zr content based on the total amount of elements in the lithium nickel-based composite oxide of the second positive active material excluding lithium and oxygen is greater than or equal to about 0.5 mol % and less than about 1.0 mol %.

4. The positive active material of claim 1, wherein, in the second positive active material, an Mg content based on the total amount of elements in the lithium nickel-based composite oxide of the second positive active material excluding lithium and oxygen is greater than or equal to about 0.1 mol % and less than about 1.0 mol %.

5. The positive active material of claim 1, wherein the lithium nickel-based composite oxide of the second positive active material is represented by Chemical Formula 4:
Liₐ₄Niₓ₄Co_{y4}Mn_{z4}Al_{b4}Zr_{c4}Mg_{d4}M⁶_{(1-x4-y4-z4-b4-c4-d4)}O₂, Chemical Formula 4
wherein, in Chemical Formula 4, 0.9≤a4≤1.8, 0.8≤x4<1, 0<y4≤0.184, 0<z4≤0.184, 0.01≤b4<0.02, 0.005≤c4<0.01, 0.001≤d4<0.01, and M⁶ is at least one element selected from B, Ba, Ca, Ce, Cr, Cu, F, Fe, Mo, Nb, P, S, Si, Sr, Ti, V, and W.

6. The positive active material of claim 1, wherein the lithium nickel-based composite oxide of the first positive active material is represented by Chemical Formula 1:
Liₐ₁Niₓ₁M¹_{y1}M²_{1-x1-y1}O₂, Chemical Formula 1
wherein, in Chemical Formula 1, 0.9≤a1≤1.8, 0.8≤x1≤1, 0≤y1≤0.2, and M¹ and M² are each independently at least one element selected from Al, B, Ba, Ca, Ce, Co, Cr, Cu, F, Fe, Mg, Mn, Mo, Nb, P, S, Si, Sr, Ti, V, W, and Zr.

7. The positive active material of claim 1, wherein an average particle diameter of the first positive active material is about 5 μm to about 25 μm, and
an average particle diameter of the second positive active material is about 0.5 μm to about 7 μm.

8. The positive active material of claim 1, wherein based on a total amount of the first positive active material and the second positive active material, the first positive active material is in an amount of about 50 wt % to about 90 wt % and the second positive active material is in an amount of about 10 wt % to about 50 wt %.

9. A rechargeable lithium battery comprising a positive electrode comprising the positive active material of claim 1, a negative electrode, and an electrolyte.
